(19) United States
(12) Patent Application Publication
(10) Pub. No.: US 2020/0005309 A1
(43) Pub. Date: Jan. 2, 2020

(54) System and Method for Mitigating Transaction Fraud by Verifying Proximity

(71) Applicant: David Klappenberger, Severna Park, MD (US)

(72) Inventor: David Klappenberger, Severna Park, MD (US)

(21) Appl. No.: 16/023,082

(22) Filed: Jun. 29, 2018

(51) Int. Cl. G06Q 20/40; G06Q 20/32; G06Q 20/34; G06Q 20/10; H04W 4/02

(52) U.S. Cl. CPC G06Q 20/4016; G06Q 20/3224; G06Q 20/3278; H04W 4/023; G06Q 20/403; G06Q 20/102; G06Q 20/34

(57) ABSTRACT

A system and method for mitigating transaction fraud by confirming a credit card is in proximity to a mobile device associated with the credit card includes a consumer attempting to make a purchase using a credit card. A credit card processing company then seeks to confirm the authenticity of the purchase by sending a request for authenticity to a mobile application running on a phone associated with the owner of the credit card. A software application running on the mobile device is programmed to transmit a RFID signal, which returned by the credit card so long as the credit card is within a predetermined distance thereof. In this manner, the application can confirm that the owner of the credit card was the person who made the purchase transaction. The application then communicates with the credit card processing company to either allow or deny the purchase transaction.

### BACKGROUND OF THE INVENTION

This invention relates generally to purchase transaction fraud detection systems and, more particularly, to a system and method for mitigating transaction fraud by confirming a credit card is in proximity to a mobile device associated with the credit card.

Credit and debit cards are frequently used by consumers to facilitate purchase transactions. A back side of a traditional credit card has a magnetic strip that contains important information for authentication and for providing the banking details needed to complete a transaction. Specifically, the magnetic strip includes a plurality of tiny magnets whose polarity may be programmed to store important data, including an associated bank account, an amount of authorized currency or credit, and other data used for authentication. In traditional retail settings, the magnetic strip is “swiped” so that the data thereon may be read in the manner of a cassette tape. More recently, an authorized user of a credit or debit card may make a purchase transaction by providing some of the information stored in the magnetic strip by telephone or internet connection with a vendor, i.e., by reciting the credit card number and expiration date. Unfortunately, an unauthorized person may obtain and use the credit card information to make purchases fraudulently. Unfortunately, an unauthorized person can obtain much of this information fraudulently merely by visually seeing the indicia imprinted on the front side of the card.

The prior art has attempted to solve the unauthorized use of another's credit card by verifying the geographic location of a credit card is consistent with the location of the purchase or vendor. Although presumably effective to guard against a portion of fraudulent purchase transactions, the existing proposals and systems still do not confirm the credit card used in a telephone or internet purchase transaction is in the possession of its rightful owner when the transaction is made or requested. For instance, a person who has fraudulently obtained viewed the face of another person's credit card, such as a waiter or a store clerk, may attempt to log onto a vendor's website or call in to an online store and make a purchase using the stolen credit card information. Unless the online vendor or the credit card processing center tasked with confirming the validity of the purchase (e.g. Merchant Services) can verify that the owner or authorized user of the credit card is in actual possession of the card, the fraudulent transaction is not prevented.

Therefore, it would be desirable to have a system and method for mitigating transaction fraud by confirming a credit card is in proximity to a mobile device associated with the credit card. When considering how reliant people are to their cell phones today, it is certainly reasonable to assume that if the credit card is within close proximity to the authorized user's cell phone that the card is also close to the card's owner.

### SUMMARY OF THE INVENTION

A system and method according to the present invention for mitigating transaction fraud by confirming a credit card is in proximity to a mobile device associated with the credit card includes a consumer making or attempting to make a purchase using a transaction device such as credit card. A credit card processing company, such as Merchant Services, then seeks to confirm the authenticity of the purchase by sending a request for authenticity to a mobile application running on a mobile computing device, e.g. a cell phone, associated with the owner of the credit card that was used to make the purchase transaction.

A software application running on the mobile communications device is programmed to determine a geographic location of the mobile computing device. The mobile communications device transmits a signal, such as a radio frequency identification (RFID) signal, which is received and returned by complementary technology integrated into a credit card so long as the credit card is within a predetermined distance of the associated mobile communications device. In this manner, the application can confirm to an acceptable degree of likelihood that the owner of the credit card was the person who made the purchase transaction. The application is also able to communicate with the credit card processing company and to make a recommendation to either allow or deny the transaction.

Therefore, a general object of this invention is to provide a system and method for mitigating transaction fraud by confirming a credit card used in a credit card transaction is in physical proximity to a mobile device associated with the credit card.

Another object of this invention is to provide the system and method for mitigating transaction fraud, as aforesaid, that includes a mobile communications device and a credit card being equipped with RFID technology such that a physical proximity between the two may be confirmed.

Still another object of this invention is to provide the system and method for mitigating transaction fraud, as aforesaid, in which an RFID tag may be embedded in the magnetic matrix of a traditional credit card.

Yet another object of this invention is to provide the system and method for mitigating transaction fraud, as aforesaid, which includes a software application running on the cell phone of an owner of a credit card and which directs confirmation of a physical proximity of an associated credit card and which communicates confirmation or denial information to a credit card processing system.

A further object of this invention is to provide the system and method for mitigating transaction fraud, as aforesaid, that is capable of discerning the geographic location of the communications device associated with the owner of a credit card that was used in a purchase transaction.

A still further object of this invention is to provide the system and method for mitigating transaction fraud, as aforesaid, that utilizes at least one of GPS data, RFID data, and Near-Field Communications (NFC) data to determine if a communications device is in close proximity to a credit card associated with the communications device.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of a system for mitigating transaction fraud according to a preferred embodiment of the present invention;

FIG. 2 is a block diagram of the electronic components of a purchase transaction device according to the present invention;

FIG. 3 is a block diagram of the electronic components of a mobile computing device according to the present invention;

FIG. 4 a flow chart illustrating the logic of a mobile software application according to the present invention;

FIG. 5a is a flow chart illustrating the logic of the electronics of a credit card operating according to the present invention illustrated using a GPS module and transmitter; and

FIG. 5b is a flow chart illustrating the logic of the electronics of a credit card operating according to the present invention illustrated using RFID elements.

### DESCRIPTION OF THE PREFERRED EMBODIMENT

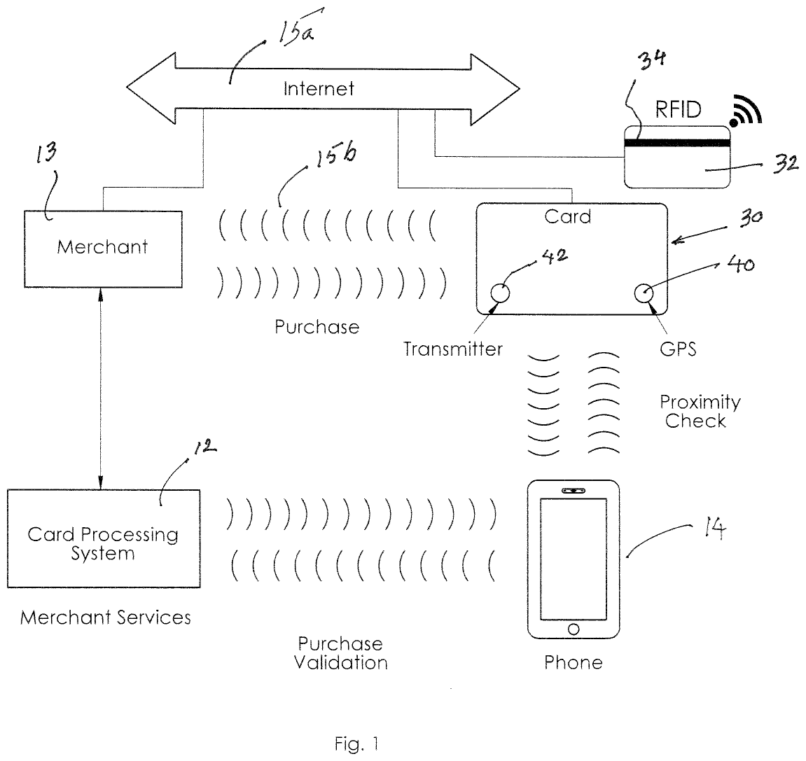

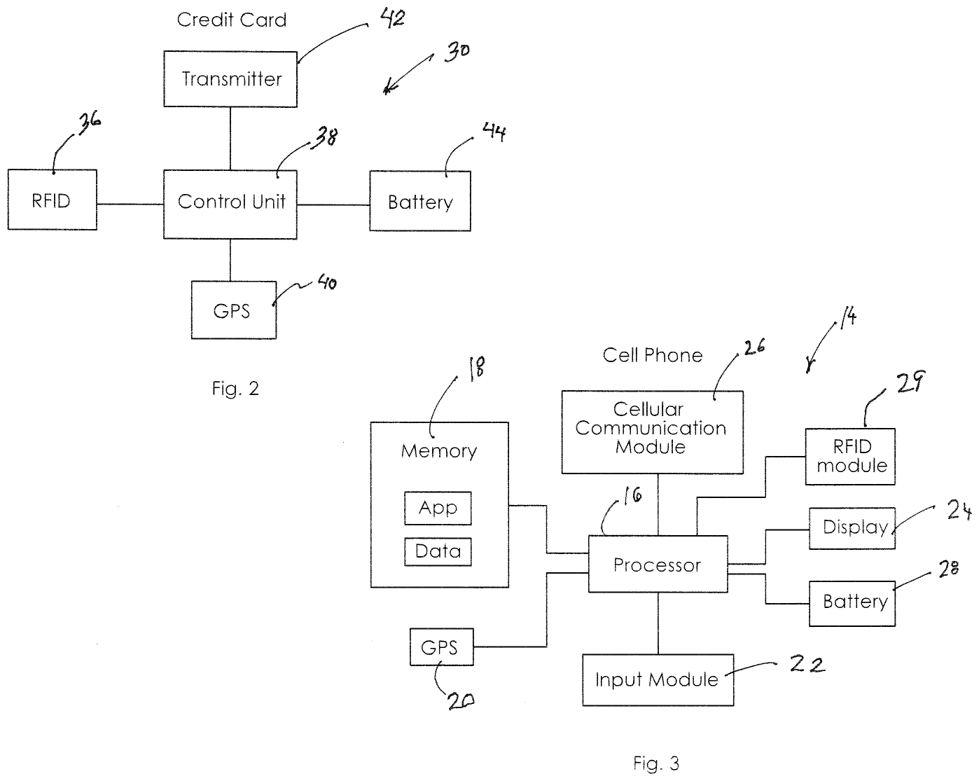

A system and method according for mitigating transaction fraud by confirming a credit card is in proximity to a mobile device associated with the credit card according to a preferred embodiment of the present invention will now be described with reference to FIGS. 1 to 5b of the accompanying drawings. The system 10 includes a transaction device 30, such as a credit card, that is configured to receive and reply to a radio frequency identification (“RFID”) signal, a mobile computing device 14 (also referred to as a mobile communications device or simply as a cell phone using the same reference numeral), and a software application 50 being executed on the mobile communications device 14.

The present invention proposes a physical change to traditional credit or debit cards, which are generically referred to herein as transaction devices. A back side 32 of a traditional credit card has a magnetic strip 34 that contains important information. The magnetic strip 34 is also referred to as a magnetic stripe or merely as a “magstripe.” The magnetic strip 34 includes coded instructions as will be described below and may appropriately be referred to as having a control unit 38 or control circuitry.

Specifically, the magnetic strip 34 includes a plurality of tiny magnets that store important data, including an associated bank account, an amount of authorized currency or credit, and other data used for authentication. Unfortunately, an unauthorized person can obtain much of this information fraudulently merely by visually seeing the indicia imprinted on the front side of the card. In traditional retail settings, the magnetic strip is “swiped” so that the data thereon may be read in the manner of a cassette tape. More recently, an authorized user of a credit or debit card may make a purchase transaction by providing some of the information stored in the magnetic strip 34 by telephone transmission 15a or internet 15b connection with a vendor or merchant 13. Unfortunately, an unauthorized person may obtain and use the credit card information to make purchases fraudulently.

Accordingly, the transaction device 30 according to the present invention includes means for signal communications with a mobile communications device 14 associated with the transaction device 30 or, more particularly, associated with the true owner of a credit card. This communication enables verification that the cell phone and presumably the owner thereof is in physical proximity to the credit card when the credit card is used to make a purchase transaction, whether that purchase is being made in person at a traditional retail store, made via telephone, or made via an internet connection with a vendor.

In an embodiment, the transaction device 30, i.e. a credit card, includes a radio frequency identification (“RFID”) module 36. Preferably, the RFID module 36 is a RFID tag embedded in the magnetic strip 34 and that may be imperceptible to the naked eye or, at least, is not obtrusive to the point of inhibiting normal storage of the credit card in a consumer's wallet.

It will be understood by persons of ordinary skill in the art that RFID uses radio waves to read and capture information stored on a tag attached to an object. An RFID system includes a tag attached to an item whose presence or proximity is to be tracked and a “reader” operable to transmit an interrogation signal to the tag. Both the tag and the reader may include transmitter and receiver circuitry. In a passive system, the tag is able to receive and return a reply signal using only the power of the interrogation signal, i.e. to function without its own power source. A reply signal received by an interrogating device (e.g. by the reader) may be interpreted by an RFID computer program so as to confirm a proximity of the tag or even to distinguish between specific tags.

In the present system, the RFID computer program may be a software application 50 running on the mobile communications device 14 such as a smart phone associated with the owner or authorized user of a credit card equipped with an embedded RFID tag or similar communications technology. The tag may be programmed with a specific serial number so that the software application 50 may distinguish between multiple similarly equipped credit cards. It is understood that the mobile communications device 14 may be referred to as a mobile computing device as it may be a cellular phone, tablet, specific RFID reader, or the like. Further, the communications device 14 will have a processor 16 capable of executing programming instructions, a non-volatile memory 18 in data communication with the processor 16 and operable to store programming instructions and data such as a serial number, and traditional electronics such as a global position satellite (GPS module 20 operable to determine a real-time geographic location of the mobile communications device 14, an input module 22 (e.g. keypad), a display 24, and a communications module 26 operable to send and receive purchase transaction data as will be described later. A battery 28 may be electrically connected to the processor 16 and to other electronic components. The mobile communications device 14 may include an RFID module 29 operable to transmit a verification signal to determine if transaction device 30 is in proximity to reply with a confirmation signal as will be described below.

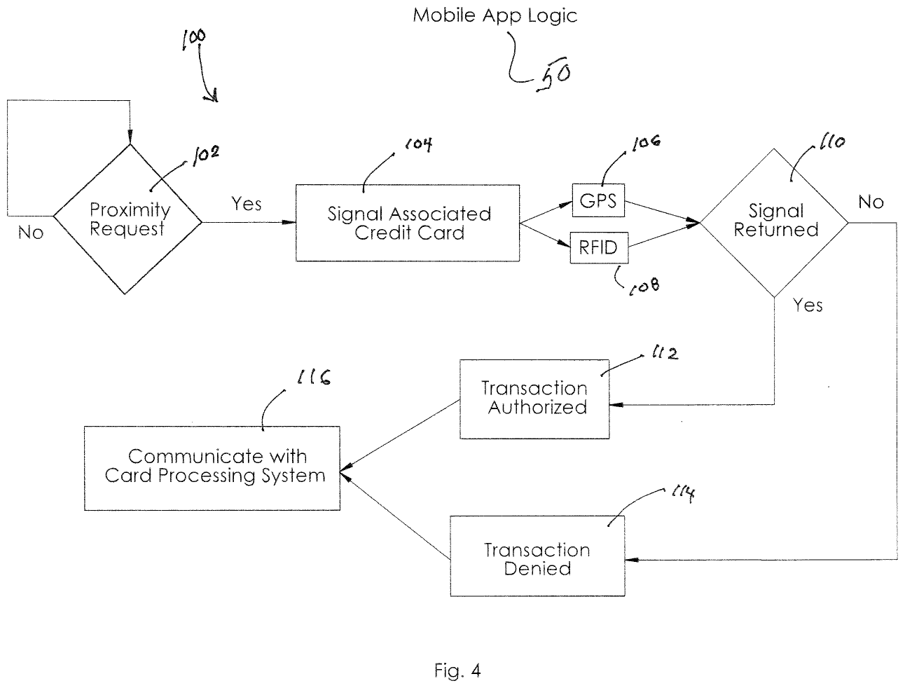

FIG. 4 is a flowchart illustrating an exemplary process 100 and method of operation of a preferred software application 50 in a system 10 that uses RFID components embedded in a transaction device 30 to determine if the transaction device 30 is within a predetermined proximity relative to a communications device 14 owned by or associated with the transaction device 30. In other words, the software application 50 is installed and running on a communications device of the owner or authorized user associated with a credit card and a credit card processing center may contact said cell phone to authenticate an attempted purchase transaction. It is understood that an identifier associated with the transaction device 30—such as a pin number or account number—is associated with the mobile computing device 14 of owned or used by a person, i.e. associated with a respective phone number. At step 102, the processor 16 of the communications device 14 determines if a proximity request has been received, such as from a credit card processing center 12 such as one known commonly as “Merchant Services.” If so, the process 100 proceeds to step 104; otherwise, the process 100 repeats step 102, i.e. waits until a proximity request is received.

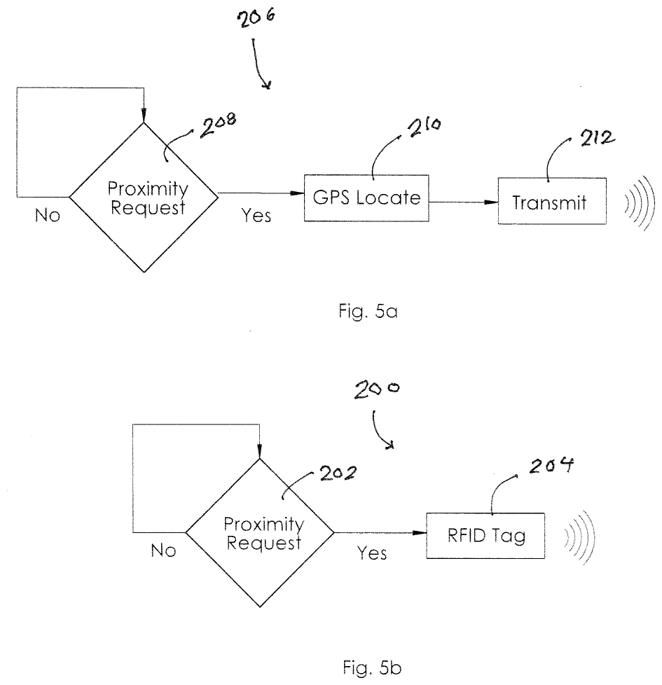

At step 104, the processor 16 determines if a transaction device 30 specified by the credit card processing center 12 is within a predetermined proximity of the communications device. To do this, the process 100 may direct the RFID module, also referred to as “the interrogator” to transmit a verification signal into the ambient air at step 108. The use of a GPS module 40 on the transaction device 30 will be described later. Similarly, a credit card receiving the verification signal from the interrogator is described below with reference to process 200 (FIG. 5b).

At step 110, the processor 16 determines if a “reply” signal was returned from the transaction device 30 (i.e. credit card) which acts as a passive RFID tag as described above. If the reply signal is received at step 110, then the processor 16 determines that the transaction device 30 is, in fact, within a predetermined proximity of the associated communications device 14 and, as a result, the process 100 proceeds to step 112 that the proposed purchase transaction should be authorized. Conversely, if no reply signal is received at step 110, then the processor 16 is programmed to determine that the transaction device 30 is not within a predetermined proximity of the associated communications device 14 and, as a result, the process 100 proceeds to step 114 that the proposed purchase transaction should be denied. In either case, the process 100 proceeds to step 116 at which the processor 16, via the communications module 26, communicates with the credit card processing system 10 (which made the original proximity request at step 102) that the purchase transaction should be allowed or denied, respectively.

Now with reference to FIG. 5b, the logic of a process 200 of operation of the present system 10 is illustrated in use when using the RFID components described above. More particularly, step 202 illustrates a credit card determining if a software application 50 running on a mobile communications device 14 has transmitted a verification signal, i.e. illustrates a repeating step of “waiting” for a verification signal to arrive. If a verification signal is received, the process 200 proceeds to step 204 and the RFID module 36 (i.e. also referred to as the RFID tag) receives an interrogator signal (i.e. radio wave) and uses the verification signal's strength and power to transmit a reply signal, also referred to as a confirmation signal. It is understood that the RFID tag component may also include a miniature receiver and transmitter combination embedded in the magnetic strip 34 on the back of the credit card. Preferably, the reply signal will include a stored serial number identifying the tag and, thus, the associated credit card identifier.

In a related embodiment, the RFID components may include or be replaced by Near-Field Communications (NFC) components. Near-field communication (NFC) is a set of communication protocols that enable two electronic devices, one of which is usually a portable device such as a smartphone, to establish communication by bringing them within 4 cm (1.6 in) of each other. NFC technology is also characterized by a reader (such as provided by a smart phone) and small tags such as stickers.

In yet another alternative embodiment and perhaps one allowing for a greater distance between a credit card and a cell phone associated therewith, the transaction device 30 may include a GPS module 40, such as one positioned on a front side of the transaction device 30, operable to determine a geographic location of the transaction device itself (FIG. 1) and a transmitter 42 operable to transmit the geographic location of the transaction device 30, so as to transmit the GPS coordinates of a credit card to the card owner's cell phone running the software application. A transaction device 30 that includes a GPS module 40 and transmitter 42 will also require the transaction device 30 to include a battery 44 electrically connected to these components. Operation of this embodiment is illustrated in FIG. 5a. Here, a process 206 illustrates a transaction device 30 awaiting a request to confirm proximity at step 208 which is operable as describe above. When a verification signal is received, the process 206 proceeds to step 210 where the GPS module 40 determines the actual, real time geographic location of the transaction device 30. The process 206 then proceeds to step 208 where the geographic location of the transaction device 30 is transmitted to the software application 50 via the transmitter 42 at step 212. Then, the respective locations of transaction device 30 and associated mobile communications device 14 are compared. Accordingly, the software application 50 is programmed to determine if the transaction device 30 is within a predetermined distance of one another. It should be appreciated that the transmittal of a proximity request and comparison of respective GPS locations corresponds to step 106 shown on FIG. 4, i.e. the software application 50 sending and receiving GPS signals in lieu of or in addition to RFID signals. Stated another way, the GPS module 20 of the mobile communications device 14 is directed to determine its own global location position and then compared with the global location of the transaction device 30.

According to the invention described above in detail, the software application 50, in communication with the transaction device 30 having RHD, GPS, NEC, or proximity related elements, is able to confirm if the credit card associated with the cell phone of the authorized user is physically in proximity therewith. It is understood that the confirmation described above may occur within seconds or even milliseconds of the purchase transaction so that a vendor is able to know immediately if the purchase transaction should be permitted or denied.

It is understood that while certain forms of this invention have been illustrated and described, it is not limited thereto except insofar as such limitations are included in the following claims and allowable functional equivalents thereof.

1. A system for mitigating transaction fraud by confirming a credit card that is separate and distinct from a mobile device is in proximity to the mobile device associated with the credit card, the system for mitigating transaction fraud comprising:
a transaction device having an identification code associated with a bank account of a user that is operable to make purchase transaction requests initiated by the user;
wherein said transaction device includes:
a global position satellite (GPS) module situated on a front face and operable to determine in real time a geographic location of said transaction device and to generate location data;
a transmitter in electronic communication with said GPS module and operable to transmit said location data;
a software application executing on a mobile computing device associated with the user and which has a global position satellite (GPS) module operable to determine a geographic location of said mobile computing device, said software application being operable to:
receive a request for verification of authenticity of a financial transaction associated with said transaction device;
determine a GPS position of the mobile computing device;
direct the mobile computing device to transmit a location signal to said GPS module on said transaction device;
wait a predetermined time to receive a reply signal from said transaction device indicative of a GPS position of said transaction device;
determine if said GPS position of said transaction device is less than a predetermined distance from said GPS position of the mobile computing device and, if so, recommend to said requester of verification of authenticity of the financial transaction that the financial transaction be allowed.

2. The system for mitigating transaction fraud as in claim 1, wherein said mobile computing device includes:
a non-volatile memory operable to store programming instructions and geographic location data;
a communications module operable to send and receive communication signals;
a processor in data communication with said memory and operable to cause said GPS module to determine a current geographic location.

3. The system for mitigating transaction fraud as in claim 2, wherein said mobile computing device includes a radio frequency Identification module (“RFID module) operable to determine if said transaction device is located within a predetermined range of the mobile computing device.

4. The system for mitigating transaction fraud as in claim 3, wherein:
said mobile computing device includes an RFID interrogator operable to transmit a location signal when actuated; and
said transaction device includes an RFID module operable to receive said location signal and to transmit automatically a confirmation signal indicative of receipt of said location signal.

5. The system for mitigating transaction fraud as in claim 1, wherein said transaction device is one of a credit card or debit card.

6. The system for mitigating transaction fraud as in claim 4, wherein:
a back side of said transaction device includes a magnetic strip that is encoded with transaction data; and
said RFID module is embedded in said magnetic strip.

7. (canceled)

8. The system for mitigating transaction fraud as in claim 1, wherein said software application is operable to receive said verification request from a credit card processing system so as to determine if a credit card transaction should be allowed or denied.

9. The system for mitigating transaction fraud as in claim 3, wherein said RFID module is a passive RFID module that receives a location signal as a radio frequency wave and returns a reply signal using only the energy from the location signal itself.

10. The system for mitigating transaction fraud as in claim 1, wherein:
said mobile computing device is a RFID reader;
said mobile computing device is equipped with a near field communications (NFC) module operable to determine proximity to an NFC tag.

11. A method for mitigating transaction fraud by confirming a credit card that is separate and remote from a mobile computing device is in proximity to the mobile computing device associated with the credit card, the method for mitigating transaction fraud comprising:
a consumer making a purchase request using a transaction device having an identification code associated with a bank account of the consumer;
receiving a request for verification of an authenticity of a financial transaction associated with said transaction device;
determining in real time a geographic location of a mobile computing device that is running a software application for verifying an authorized purchase;
transmitting a signal from the mobile computing device requesting a global position of said transaction device, said transaction device having a GPS module operable for receiving said request for a geographic location of said transaction device;
receiving a reply signal from the GPS module of said transaction device indicative of a geographic location of the transaction device;
determining if said geographic location of said transaction device is less than a predetermined distance from said geographic position of the mobile computing device and, if so, recommend to said requester of verification of authenticity of the financial transaction that the financial transaction be allowed.

12. The method for mitigating transaction fraud as in claim 11, wherein said transaction device is one of a credit card or debit card that is separate and not integrated into the mobile computing device.

13. The method for mitigating transaction fraud as in claim 11, wherein the step of transmitting a signal from the mobile computing device includes transmitting a radio frequency identification (RFID) signal from the mobile transaction device, said method for mitigating transaction fraud further comprising:
the transaction device having an RFID module operably receiving the RFID signal and operably returning a confirmation signal in reply that is indicative that said transaction device is within the predetermined geographic proximity of the mobile computing device.

14. The method for mitigating transaction fraud as in claim 13 wherein said mobile computing device includes a radio frequency Identification module (“RFID module) operable to determine if said transaction device is located within a predetermined range of the mobile computing device.

15. The method for mitigating transaction fraud as in claim 13, wherein:
a back side of said transaction device includes a magnetic strip that is encoded with transaction data; and
said RFID module is embedded in said magnetic strip.

16. The method for mitigating transaction fraud as in claim 15, wherein said RFID module is a passive RFID module that receives a location signal as a radio frequency wave and returns a reply signal using only the energy from the location signal itself.

17. The method for mitigating transaction fraud as in claim 11, wherein said step of receiving a request for verification of the authenticity of a financial transaction includes receiving a verification request from a credit card processing entity.

18. (canceled)

19. The system for mitigating transaction fraud as in claim 13, wherein:
said mobile computing device is a RFID reader device; and
said mobile computing device is equipped with a near field communications (NFC) module operable to determine proximity to an NFC tag.

20. The system for mitigating transaction fraud as in claim 13, wherein said mobile computing device includes:
a non-volatile memory operable to store programming instructions and geographic location data;
a communications module operable to send and receive communication signals;
a processor in data communication with said memory and operable to cause said GPS module to determine a current geographic location.
